(19) United States
(12) Patent Application Publication
(10) Pub. No.: US 2002/0016648 A1
(43) Pub. Date: Feb. 7, 2002

(54) Numerical controlling unit

(76) Inventors: Jun Fujita, Mishima-Shi (JP); Minoru Hamamura, Numazu-Shi (JP); Sadaji Hayama, Tochigi-Ken (JP)

Correspondence Address: Pillsbury Madison & Sutro LLP, Cushman Darby & Cushman, Intellectual Property Group, 1100 New York Ave., N.W., East Tower, Ninth Floor, Washington, DC, 20005-3918, US

(21) Appl. No.: 09/785,414

(22) Filed: Feb. 20, 2001

(30) Foreign Application Priority Data
Feb. 18, 2000 (JP) 040772/2000

(51) Int. Cl. G06F 19/00

(52) U.S. Cl. 700/188

(57) ABSTRACT

The invention relates to a numerical controlling unit 10 having a speed-feedback controlling system. A peak-frequency detector 20 determines a peak frequency from a characteristic of a frequency transfer function whose input is a speed-instruction input signal and whose output is a speed feedback signal. A band elimination component 30 conducts a band elimination process to the speed-instruction input signal, based on the peak frequency.

### BACKGROUND OF THE INVENTON

1. Field of the Invention

The present invention relates to a numerical controlling unit having a speed-feedback controlling system that can reduce a gain of a peak frequency of the speed-feedback controlling system.

2. Decription of the Related Art

For example, as shown in FIG. 3, in a speed-feedback controlling system for a feeding control in a machining center incuding a ball screw, there is a peak of gain that is caused by a torsional resonance of the ball screw. A frequency coresponding to the peak of gain is called a peak frequency or a resonance frequency. A peak frequency of the example shown in FIG. 3 is about 400 Hz.

When a gain of a speed controlling system for a servo control is increased, because of the peak of gain, a peak of torsional vibration is also increased over 0 dB so that an oscillating phenomenon may happen. Thus, there is a a limit to increase the gain of the speed controlling system. Therefore, it may be impossible to obtain a necessary resonance characteristic or a necessary disturbance characteristic.

### SUMMARY OF THE INVENTION

Therefore, the object of the present invention is to provide a numerical controlling unit that can reduce a gain of a peak frequency of a speed controlling system in order to allow a gain of the speed controlling system to be increased to a certain level.

To achieve the above object, the present invention is characterized by following features. That is, the present invention is a numerical controlling unit having a speed-feedback controlling system comprising: a peak-frequency detector that can determine a peak frequency from a frequency transfer function whose input is a speed-instruction input signal and whose output is a speed feedback signal; and a band elimination component that can conduct a band elimination process to the speed-instruction input signal, based on the peak frequency.

According to the feature, the band elimination process can be conducted based on the peak frequency determined by the peak-frequency detector. Thus, a gain of the peak frequency can be reduced effectively.

Preferably, the peak-frequency detector includes: a white-noise generator that can generate a white-noise input signal; a switch that can change the speed-instruction input signal into the white-noise input signal generated by the white-noise generator; and an FFT (fast Fourier transform) processing component that can determine a gain characteristic of the frequency transfer function whose input is the white-noise input signal and whose output is the speed feedback signal and that can determine the peak frequency. In the case, the gain characteristic of the frequency transfer function can be determined more easily, and the peak frequency can be determined more precisely.

Preferably, the band elimination component includes: a band elimination filter that can conduct the band elimination process according to set filter-parameter; and a parameter changing component that can change the filter-parameter for the band elimination filter, based on the peak frequency. In the case, a suitable filtering characteristic corresponding to the peak frequency can be easily achieved.

In addition, preferably, the filter-parameter for the band elimination filter can be set such that the band elimination process is ineffectual. In the case, the gain characteristic of the frequency transfer function can be determined more precisely without affected by the band elimination filter.

In addition, preferably, an automatic adjuster is connected to the white-noise generator, the switch, the FFT processing component and the band elimination filter, and the automatic adjuster has: a function for causing the switch to change the speed-instruction input signal into the white-noise input signal generated by the white-noise generator; a function for setting filter-parameter such that the band elimination process is ineffectual, for the band elimination filter; a function for causing the white-noise generator to output the white-noise input signal; a function for causing the FFT processing component to determine the gain characteristic of the frequency transfer function whose input is the white-noise input signal and whose output is the speed feedback signal, and to detemine the peak frequency; and a function for causing the switch to change back from the white-noise input signal into the original speed-instruction input signal.

In the case, the band elimination process based on the peak frequency can be automatically conducted by the automatic adjuster. Thus, the gain of the peak frequency can be reduced more easily.

In addition, preferably, the white-noise input signal has an amplitude that is randomly generated, and a period that is the same as a controlling period of the speed-feedback controlling system.

In addition, the present invention is a method of using a numerical controlling unit that has a speed-feedback controlling system,

the numerical controlling unit including: a peak-frequency detector that can determine a peak frequency from a frequency transfer function whose input is a speed-instruction input signal and whose output is a speed feedback signal; and a band elimination component that can conduct a band elimination process to the speed-instruction input signal, based on the peak frequency; wherein the peak-frequency detector includes: a white-noise generator that can generate a white-noise input signal; a switch that can change the speed-instruction input signal into the white-noise input signal generated by the white-noise generator; and an FFT processing component that can determine a gain characteristic of the frequency transfer function whose input is the white-noise input signal and whose output is the speed feedback signal and that can determine the peak frequency; the band elimination component includes: a band elimination filter that can conduct the band elimination process according to set filter-parameter; and a parameter changing component that can change the filter-parameter for the band elimination filter, based on the peak frequency; and the filter-parameter for the band elimination filter can be set such that the band elimination process is ineffectual;

the method comprising: a step for causing the switch to change the speed-instruction input signal into the white-noise input signal generated by the white-noise generator; a step for setting filter-parameter such that the band elimination process is ineffectual, for the band elimination filter; a step for causing the white-noise generator to output the white-noise input signal; a step for causing the FFT processing component to determine the gain characteristic of the frequency transfer function whose input is the white-noise input signal and whose output is the speed feedback signal, and to determine the peak frequency; a step for causing the parameter changing component to change the filter-parameter for the band elimination filter, based on the determined peak frequency; a step for causing the white-noise generator to stop outputting the white-noise input signal; and a step for causing the switch to change back from the white-noise input signal into the original speed-instruction input signal.

### BRIEF DESCRIPTION OF THE DRAWINGS

The above and further objects and novel features of the present invention will be more fully apparent from the following detailed description which the same is read in conjunction with the accompanying drawings, in which

FIG. 1 is a schematic block diagram of a first embodiment of a numerical controlling unit according to the present invention;

FIG. 2 is a graph showing an example of a white noise;

FIG. 3 is a Bode diagram showing an example of a gain characteristic;

FIG. 4 is a diagram showing an example of a filtering characteristic of an IIR band elimination filter; and

FIG. 5 is a flowchart showing an operation of the numerical controlling unit shown in FIG. 1.

### BEST MODE FOR CARRYING OUT THE INVENTION

Embodiments of the invention are explained in more detail with reference to the drawings.

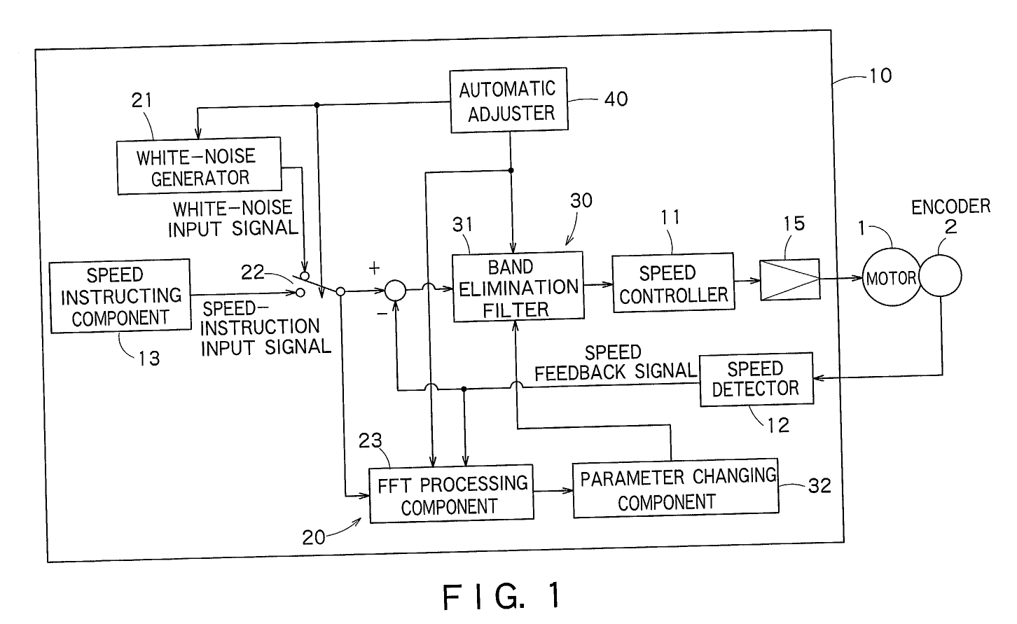

FIG. 1 is a schematic block diagram of a first embodiment of a numerical controlling unit according to the invention. As shown in FIG. 1, the numerical controlling unit 10 is connected to a motor 1 that is an object to be controlled, and an encoder 2 that is arranged for a position-feedback control of the motor 1.

The numerical controlling unit 10 has a speed controller 11 that is connected to the motor 1 via an amplifier 15, a speed detector 12 that is connected to the encoder 2, and a speed instructing component 13 that is adapted to transmit a speed-instruction input signal to the speed controller 11. The speed detector 12 is adapted to determine (find) a speed signal from a position signal of the motor 1 detected by the encoder 2. Then, the speed detector 12 is adapted to generate a speed feedback signal based on the speed signal. The speed feedback signal and the speed-instruction input signal transmitted from the speed instructing component 13 are fusedly adapted to be input into the speed controller 11. That is, a speed-feedback controlling system is formed.

In addition, the numerical controlling unit 10 has a peak-frequency detector 20 that can determined a peak frequency from a characteristic of a frequency transfer function whose input is the speed-instruction input signal and whose output is the speed feedback signal.

The peak-frequency detector 20 has a white-noise generator 21 that can generate a white-noise input signal, a switch 22 that can replace the speed-instruction input signal with the white-noise input signal generator by the white-noise generator 21, and an FFT (fast Fourier Transform) processor 23 that can determine a gain characteristic of the frequency transfer function whose input is the white-noise input signal and whose output is the speed feedback signal by using an FFT process and thus that can determine the peak frequency.

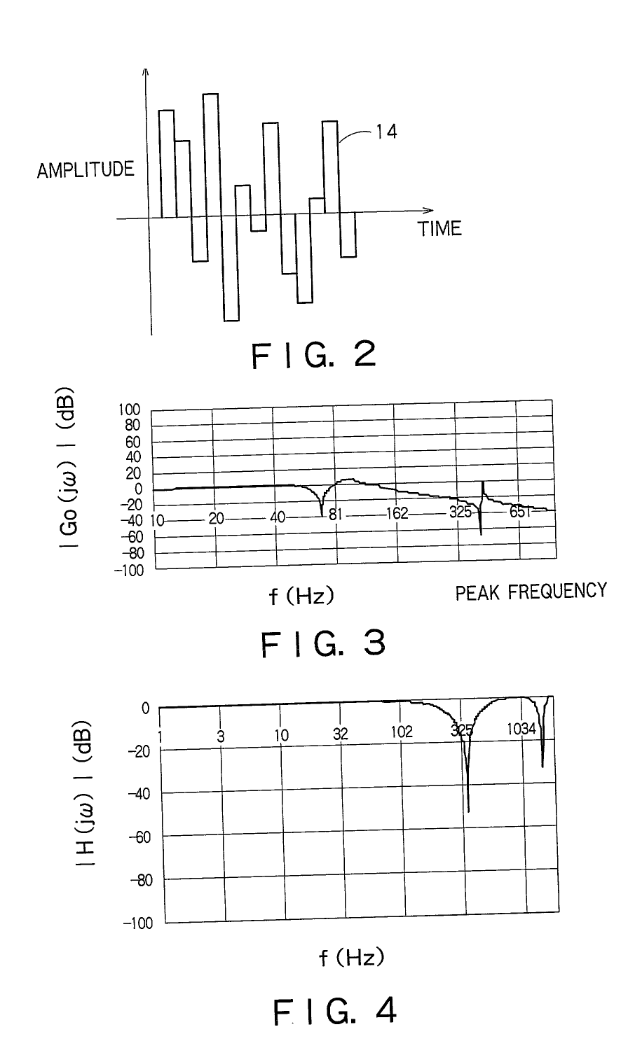

In the case, as shown in FIG. 2, the white-noise generator 21 is adapted to generate a white-noise input signal that has frequency components covering a necessary frequency band. In addition, the white-noise input signal has amplitude that is randomly generated and a period that is the same as a controlling period of the speed-feedback controlling system.

An example of a gain characteristic of the frequency transfer function is shown in FIG. 3. In the case, the peak frequency is about 400 Hz.

In addition, the numerical controlling unit 10 has a band elimination (rejection) component 30 has a band elimination filter 31 that can conduct the band elimination process according to set filter-parameter, and a parameter changing components 32 that can change the filter-parameter for the band elimination filter 31, based on the peak frequency.

Herein, in the band elimination filter 31, the filter-parameter can be set such that the band elimination process by the band elimination filter 31 is ineffectual.

As a band elimination filter 31, an FIR (Finite Impulse Response) filter, an IIR (Infinite Impulse Response) filter or the like may be used. An example of a filtering characteristic of an IIR band elimination filter is shown in FIG. 4.

In addition, in the embodiment, an automatic adjuster 40 is connected to the white-noise generator 21, the switch 22, the FFT processing component 23 and the band elimination filter 24.

The automatic adjuster 40 has a function for causing the switch 22 to change the speed-instruction input signal into the white-noise input signal generated by the white-noise generator 21, a function for setting filter-parameter such that the band elimination process by the band elimination filter 31 is ineffectual, a function for causing the white-noise generator 22 to output the white-noise input signal, a function for causing the FFT processing component 23 to determine the gain aracteristic of the frequency transfer function whose input is the white-noise input signal and whose output is the speed feedback signal by using the FFT process and to determine the peak frequency, and a function for causing the switch 22 to change back from the white-noise input signal into the original speed-instruction input signal.

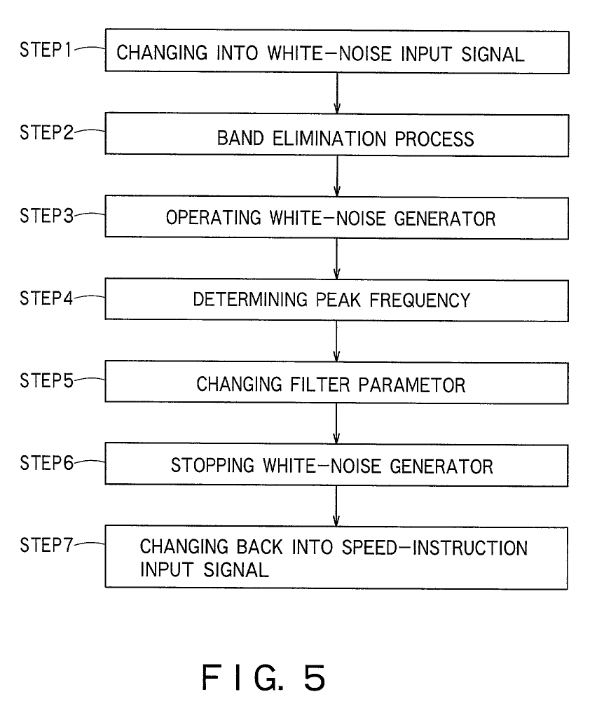

Then, an operation of the embodiment is explained as below with reference to FIG. 5, which is a flowchart for showing the operation of the numerical controlling unit shown in FIG. 1.

As shown in FIG. 5, at first, the automatic adjuster 40 causes the switch 22 to replace the speed-instruction input signal transmitted from the speed instructing component 13 with the white-noise input signal transmitted from the white-noise generator 21 (STEP1).

Then, for the band elimination filter 31, the automatic adjuster 40 sets filter-parameter such that the band elimination process by the band elimination filter 31 is ineffectual (STEP2).

Then, the automatic adjuster 40 causes the white-noise generator 21 to output the white-noise input signal, as a substitute of the speed-instruction input signal (STEP3).

Then, the automatic adjuster 40 causes the FFT processing component 23 to determine the gain characteristic of the frequency transfer function whose input is the white-noise input signal and whose output is the speed feedback signal, and to determine the peak frequency from the gain characteristic (STEP4). For example, the peak frequency of about 400 Hz may be determined from the gain characteristic shown in FIG. 3.

Then, the automatic adjuster 40 causes the parameter changing component 32 to change the filter-parameter for the band elimination filter 31, based on the determined peak frequency (STEP5). Because of the change of the filter-parameter, for example, the band elimination filter 31 may be adjusted to a filtering characteristic as shown in FIG. 4, which can reduce the gain of the peak frequency that is about 400 Hz.

Then, the automatic adjuster 40 causes the white-noise generator 21 to stop outputting the white-noise input signal (STEP6), and causes the switch 22 to change back from the white-noise input signal into the original speed-instruction input signal transmitted from the speed instructing component 13 (STEP7).

As described above, according to the embodiment, the band elimination process can be conducted based on the peak frequency determined by the peak-frequency detector 20. Thus, the gain of the peak frequency can be reduced effectively. Thus, a gain of the speed frequency can be reduced effectively. Thus, a gain of the speed controlling system can be increased to a desired level.

In the embodiment, since the FFT processing component 23 can determine the gain characteristic of the frequency transfer function whose input is the white-noise input signal and whose output is the speed feedback signal by using the FFT process and that can determine the peak frequency, the gain characteristic of the frequency transfer function can be determined more easily, and the peak frequency can be determined more precisely.

In addition, in the embodiment, since the band elimination component 30 has the band elimination filter 31 that can conduct the band elimination process according to the set filter-parameter and the parameter changing component 32 that can change the filter-parameter for the band elimination filter 31 based on the peak frequency, any suitable filtering characteristic corresponding to the peak frequency can be easily achieved.

In addition, in the embodiment, the filter-parameter for the band elimination filter 31 can be set such that the band elimination process by the band elimination filter 31 is ineffectual. Thus, the gain characteristic of the frequency transfer function can be determined more precisely without affected by the band elimination filter 31.

In addition, in the embodiment, the band elimination process based on the peak frequency can be automatically conducted by the automatic adjuster 40. Thus, the gain of the peak frequency can be reduced more easily.

According to the invention, since a band elimination process cna be conducted based on a peak frequency determined by a peak-frequency detector, a gain of the peak frequency can be reduced effectively. Thus, a gain of a speed controllign system can be increased to a desired level.

It should be understood, of course, that the foregoing disclosure relates only to preferred embodiments of the invention, and that it is intended to cover all changes and modifications of the example of the invention herein chosed for the purpose of the disclosure which does not constitute departures from the spirit and scope of the invention set forth in the appended claims.

What is claimed is:

1. A numerical controlling unit having a speed-feedback controlling system comprising;
a peak-frequency detector that can determine a peak frequency from a frequency transfer function whose input is a speed-instruction input signal and whose output is a speed feedback signal, and
a band elimination component that can conduct a band elimination process to the speed-instruction input signal, based on the peak frequency.

2. A numerical controlling unit according to claim 1, wherein:
the peak-frequency detector includes:
a white-noise generator that can generate a white-noise input signal,
a switch that can change the speed-instruction input signal into the white-noise input signal generated by the white-noise generator, and
an FFT processing component that can determine a gain characteristic of the frequency transfer function whose input is the white-noise input signal and whose output is the speed feedback signal and that can determine the peak frequency.

3. A numerical controlling unit according to claim 2, wherein:
the band elimination component includes:
a band elimination filter that can conduct the band elimination process according to set filter-parameter, and
a parameter changing component that can change the filter-parameter for the band elimination filter, based on the peak frequency.

4. A numerical controlling unit according to claim 3, wherein:
the filter-parameter for the band elimination filter can be set such that the band elimination process is ineffectual.

5. A numerical controlling unit according to claim 4, wherein:
an automatic adjuster is connected to the white-noise generator, the switch, the FFT processing component and the band elimination filter, and
the automatic adjuster has:
a function for causing the switch to change the speed-instruction input signal into the white-noise input signal generated by the white-noise generator,
a function for setting filter-parameter such that the band elimination process is ineffectual, for the band elimination filter,
a function for causing the white-noise generator to output the white-noise input signal,
a function for causing the FFT processing component to determine the gain characteristic of the frequency transfer function whose input is the white-noise input signal and whose output is the speed feedback signal, and to determine the peak frequency, and
a function for causing the switch to change back from the white-noise input signal into the original speed-instruction input signal.

6. A numerical controlling unit according to claim 2, wherein:
the white-noise input signal has an amplitude that is randomly generated, and a period that is the same as a controlling period of the speed-feedback controlling system.

7. A numerical controlling unit according to claim 3, wherein:
the white-noise input signal has an amplitude that is randomly generated , and a period that is the same as a controlling period of the speed-feedback controlling system.

8. A numerical controlling unit according to claim 4, wherein:
the white-noise input signal has an amplitude that is randomly generated, and a period that is the same as a controlling period of the speed-feedback controlling system.

9. A numerical controlling unit according to claim 5, wherein:
the white-noise input signal has an amplitude that is randomly generated, and a period that is the same as a controlling period of the speed-feedback controlling system.

10. A numerical controlling unit having a speed-feedback controlling system comprising;
a peak-frequency detector that can determine a peak frequency from a frequency transfer function whose input is a speed-instruction input signal and whose output is a speed feedback signal, and
a band elimination component that can conduct a band elimination process to the speed-instruction input signal that has been fused with the speed feedback signal, based on the peak frequency.

11. A numerical controlling unit according to claim 10, wherein:
the peak-frequency detector includes:
a white-noise generator that can generate a white-noise input signal,
a switch that can change the speed-instruction input signal into the white-noise input signal generated by the white-noise generator, and
an FFT processing component that can determine a gain characteristic of the frequency transfer function whose input is the white-noise input signal and whose output is the speed feedback signal and that can determine the peak frequency.

12. A numerical controlling unit according to claim 11, wherein:
the band elimination component includes:
a band elimination filter that can conduct the band elimination process according to set filter-parameter, and
a parameter changing component that can change the filter-parameter for the band elimination filter, based on the peak frequency.

13. A numerical controlling unit according to claim 12, wherein:
the filter-parameter for the band elimination filter can be set such that the band elimination process is ineffectual.

14. A numerical controlling unit according to claim 13, wherein:
an automatic adjuster is connected to the white-noise generator, the switch, the FFT processing component and the band elimination filter, and
the automatic adjuster has:
a function for causing the switch to change the speed-instruction input signal into the white-noise input signal generated by the white-noise generator,
a function for setting filter-parameter such that the band elimination process is ineffectual, for the band elimination filter,
a function for causing the white-noise generator to output the white-noise input signal,
a function for causing the FFT processing component to determine the gain characteristic of the frequency transfer function whose input is the white-noise input signal and whose output is the speed feedback signal, and to determine the peak frequency, and
a function for causing the switch to change back from the white-noise input signal into the original speed-instruction input signal.

15. A method of using a numerical controlling unit that has a speed-feedback controlling system, the numerical controlling unit including
a peak-frequency detector that can determine a peak frequency from a frequency transfer function whose input is a speed-instruction input signal and whose output is a speed feedback signal, and
a band elimination component that can conduct a band elimination process to the speed-instruction input signal, based on the peak frequency,
wherein
the peak-frequency detector includes:
a white-noise generator that can generate a white-noise input signal,
a switch that can change the speed-instruction input signal into the white-noise input signal generated by the white-noise generator, and
an FFT processing component that can determine a gain characteristic of the frequency transfer function whose input is the white-noise input signal and whose output is the speed feedback signal and that can determine the peak frequency,
the band elimination component includes:
a band elimination filter that can conduct the band elimination process according to set filter-parameter, and
a parameter changing component that can change the filter-parameter for the band elimination filter, based on the peak frequency, and
the filter-parameter for the band elimination filter can be set such that the band elimination process is ineffectual, the method comprising the steps of:
causing the switch to change the speed-instruction input signal into the white-noise input signal generated by the white-noise generator,
setting filter-parameter such that the band elimination process is ineffectual, for the band elimination filter,
causing the white-noise generator to output the white-noise input signal,
causing the FFT processing component to determine the gain characteristic of the frequency transfer function whose input is the white-noise input signal and whose output is the speed feedback signal, and to determine the peak frequency,
causing the parameter changing component to change the filter-parameter for the band elimination filter, based on the determined peak frequency,
causing the white-noise generator to stop outputting the white-noise input signal, and
causing the switch to change back from the white-noise input signal into the original speed-instruction input signal.
